(19) United States
(12) Patent Application Publication
(10) Pub. No.: US 2002/0153410 A1
(43) Pub. Date: Oct. 24, 2002

(54) Prepaid cellular phone easy activation model

(76) Inventor: Wayne Santini, Coral Springs, FL (US)

Correspondence Address: MCHALE & SLAVIN, 4440 PGA BLVD, SUITE 402, PALM BEACH GARDENS, FL, 33410

(21) Appl. No.: 09/838,900

(22) Filed: Apr. 19, 2001

(51) Int. Cl. G06F 17/00

(52) U.S. Cl. 235/375

(57) ABSTRACT

The instant invention is an apparatus and method of prepaying for cellular phone time without having to leave a vehicle. A national/international retail or food chain with drive-thru windows will host activation boxes. A customer will have bought an approved cellular phone with a limited number of prepaid minutes and an activation card. The customer will call the customer service number on the activation card to activate the cellular phone. Whenever the customer desires additional minutes, the customer simply presents their activation card along with any other purchases they may have to a cashier at the drive-thru window at any location with an activation box. The cashier swipes the activation card through the activation box, inputs the number of minutes purchased, and rings the amount into the register. This information, i.e. the customer's cellular phone identification and minutes purchased, are transmitted to an activation center. The activation center then credits the additional prepaid minutes to the customers phone number. As a result, additional minutes can be easily and conveniently purchased without the customer leaving their vehicle.

### FIELD OF THE INVENTION

This invention relates generally to prepaid phone time and more particularly to an apparatus and method of prepaying for cellular phone time.

### BACKGROUND OF THE INVENTION

The ability to contact or to be contacted at any time and/or place is often desirable and sometimes essential. Working parents need to be able to communicate with their children especially when the children are out of school. For anyone, an especially for females, it is no longer wise and often unsafe to depend upon a stranger's help during unexpected emergencies such as a car breakdown. If both the husband and wife work, or any two people, immediate access to one another is desirable to coordinate schedules when unanticipated events change previous plans. Further, many people just want the convenience of being able to easily and quickly contact another. For example: when shopping i.e. forgot a size or color preference; doing errands i.e. can't remember which cold tablet to buy; if running late, i.e. want to be courteous and notify the other party; for business use, i.e. small or home office or SOHO markets.

Pagers, which are inexpensive and easily accessible, provide the ability to be contacted but access to a phone is needed for two-way real time communication. Should there be an emergency and the immediate need to speak with another is needed, pagers are ineffective. Cellular phones provide immediate speaking contact but many people are unable or unwilling to purchase them. People without acceptable credit or those with no credit are often denied a cellular phone or required to submit a large deposit. Most teenagers and young children do not have credit and if parents want them to have a phone, the parents must put them on their plan. This is often undesirable as teenagers tend to spend many hours on the phone and could easily exceed the number of prepaid minutes. Additionally, many people would like the convenience of a cellular phone for emergencies or quick calls but never use the minutes paid for. These people do not want the additional monthly bill and thus do not have a cellular phone.

The debit phones currently on the market require the purchaser of air time to leave their vehicle, enter a store, and then wait in line. This is inconvenient for many people especially the elderly, disabled, and those with small children.

Thus, what is needed in the art is a method and apparatus for easily and conveniently prepaying for cellular phone time that doesn't require leaving a vehicle.

### SUMMARY OF THE INVENTION

The instant invention is a method and apparatus for easily and conveniently prepaying for cellular phone time that doesn't require leaving a vehicle. A large national or international retailer with a drive-thru window, such as but not limited to the fast food retailer McDonalds, would provide the distribution infrastructure and locations. For illustrative purposes McDonalds will be used throughout; the fast food chain has over 12,000 locations throughout the fifty states and has over 20,000 locations in 91 countries.

At each participating McDonalds, prepaid cellular phones and corresponding accessories would be displayed in a convenient free-standing display within the store. A customer wishing to participate in the prepaid service will choose the cellular phone of their choice. The cellular phone will come with a prepaid number of minutes, for example thirty. The customer will pay for the cellular phone plus any additional minutes, selected options, and/or accessories they may desire.

If additional minutes are purchased, a cashier will remove an activation card, similar to a credit card with a magnetic strip on the back, from a box containing the cellular phone, swipe the activation card through an activation box, and input onto a keypad the additional minutes purchased. The cashier will then replace the activation card in the box and return the box to the customer. The customer will then, at their convenience, call the customer service center number preferably located on the activation card, identify themselves, and then read off the serial number on the back of the phone to an operator at a customer service center. The customer service center will activate the cellular phone. From that point on, the customer will not have to call to reactivate the phone when additional minutes are purchased.

As the customer needs additional minutes, the customer will present the activation card to a cashier at McDonald's drive-thru. The cashier will swipe the activation box with the activation card and then input onto the keypad the number of minutes purchased. When swiped, the cards purpose is to identify the cellular phone to which the minutes are to be assigned to at the activation center. The activation center will then credit that number of minutes to the customer's cellular phone number. Depending upon the phone model purchased, the activation center may either automatically reactivate the customers cellular phone with the correct amount of pre-paid minutes; or a reactivation number may be issued which will be printed on the customer's receipt after the cashier rings up the minutes purchased along with any other purchases. If the reactivation number is issued, the customer will enter the number into their cellular phone to reactivate the phone. In this way, a customer may easily and conveniently prepay for cellular phone time without leaving their vehicle.

Accordingly, it is an objective of the instant invention to disclose an apparatus for activating prepaid cellular phone time.

It is a further objective of the instant invention to disclose a method for prepaying for cellular phone by installing a credit card swipe prepayment apparatus at locations of a national and/or international business chain.

Its is yet another object of the instant invention to disclose a method to easily and conveniently prepay for cellular phone time without the purchaser leaving their vehicle.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a flowchart of the pre-purchase of the phone phase.

FIG. 2 is a diagramatic view of the instant invention.

FIG. 3 is a flowchart of the post-purchase of the phone phase.

FIG. 4 is a flowchart of some features of the invention.

### DETAILED DESCRIPTION OF THE INVENTION

The instant invention is a method for easily and conveniently prepaying for cellular phone time that does not require leaving the vehicle. A large national or international retailer with drive-thru windows, such as the fast food chain McDonalds, will provide the distribution infrastructure and locations. For illustrative purposes McDonalds will be used throughout; the fast food chain has over 12,000 locations throughout the fifty states and has over 20,000 locations in 91 countries.

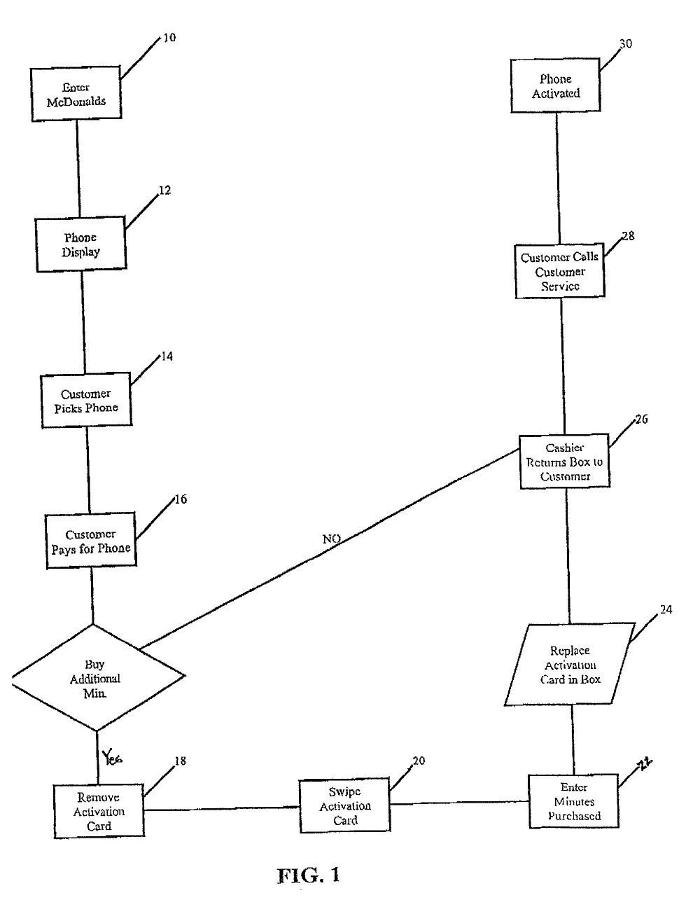

Now referring to FIG. 1, the pre-purchase of the phone phase. At each participating McDonalds 10, the prepaid cellular phones and corresponding accessories would be displayed at a convenient area in the store 12. Preferably the display will be a counter top or free standing display although any manner of displaying the merchandise is acceptable. A customer wishing to participate in the prepaid service will choose the cellular phone of their choice from a variety of styles and colors 14. The cellular phone will come with a prepaid number of minutes, for example thirty. The customer will then pay for the cellular phone plus any additional minutes, selected options, and/or phone accessories they may desire 16.

If additional minutes are purchased, a cashier will remove an activation card from a box containing the cellular phone 18, swipe the activation card through an activation box 20, and enter onto a keypad any additional minutes purchased 22. The cashier will then replace the activation card back into the box 24 and return it to the customer 26. To activate the phone, the customer must call the customer service number, identify themselves, and read off the serial number from the back of the phone to the customer service center 28. The customer service center will activate the cellular phone 30. From this point on, the customer will not have to call the service center to activate additional minutes purchased.

In an alternative method, the cellular phones will not be sold at McDonalds but at selected retailers. However, the airtime will still be purchased at McDonalds. In a further alternative method, in addition to selling the cellular phones at McDonalds, the cellular phones, but not air time, may be sold at selected retailers. For example, selling the cellular phones may not be feasible at all McDonalds locations, some restaurants may not have the counter top space or floor space for the displays. Instead, the cellular phones will be sold at select retailers in the area but McDonalds will carry the apparatus for buying additional minutes.

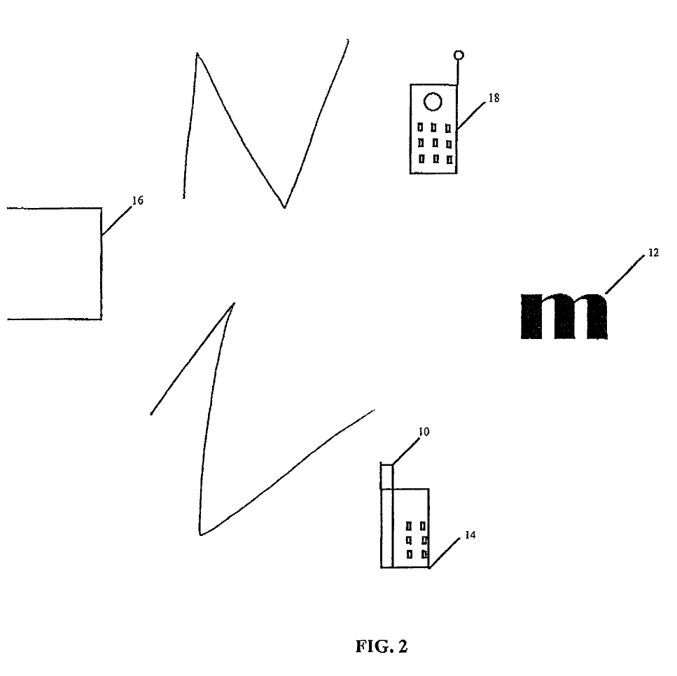

Now referring to FIG. 2, in the box containing a cellular phone will be an activation card 10. The activation card 10 is preferably a plastic card with a magnetic strip on one side. Alternatively, the activation card may be a thick paper card much like many membership cards. The thick paper card will have a bar code on one side. In a further alternative embodiment, the activation card will be a thin paper, much like a check, with a string of numbers along the bottom. The purpose of the activation card is to identify to the activation center the cellular phone that the purchased minutes are to be assigned. For example, the serial number of the phone may be encoded on the magnetic strip, bar code or string of numbers on the activation card. The activation card may also contain additional information such as the customer service number.

As the customer needs additional minutes, the customer will present their activation card 10 to a cashier at Mcdonalds 12. The cashier will swipe the card 10 through the activation box 14 and then input the minutes purchased onto a keypad. When swiped, the purpose of the activation card 10 is to identify the cellular phone to which the minutes are to be assigned to at an activation center 16. This information, the cellular phone and the minutes purchased, are transmitted tp the activation center 16. Finally, the cashier rings up the minutes purchased along with any other purchases.

After receiving the transmitted information, the activation center 16 will then credit that number of minutes to that customer's cellular phone 18. Depending on the pone model purchased, the activation center may automatically reactivate the customer's phone or a reactivation number will be issued to the customer for activation. If a number is issued, that number will be printed on the customer's receipt. At their convenience, the customer will enter that number into their cellular phone to reactivate the phone.

The quantity of McDonalds are numerous, throughout the fifty states and in ninety-one countries. Additionally, the restaurants are usually located in convenient areas and have drive-thru windows. Thus, a large national/international retail/food chain is the ideal setting for the distribution infrastructure and locations of the instant invention. By incorporating McDonalds as the framework, i.e. the location of the activation boxes, a customer can easily and conveniently purchase additional minutes without ever leaving their vehicle.

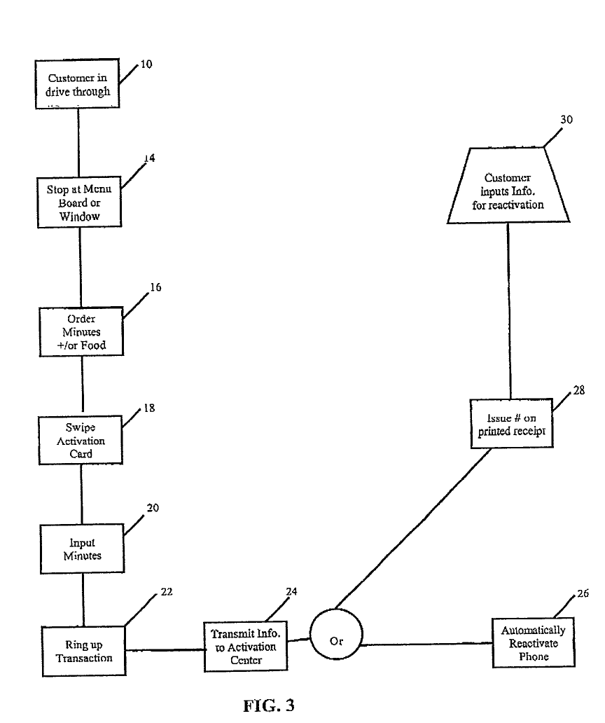

Now referring to FIG. 3, the post-purchase of the phone phase. After the phone has been purchased and the original number of minutes exhausted, a phone user may easily and conveniently purchase additional air time without leaving their vehicle. For example, while purchasing a burger and fries from the drive-thru, the customer can also purchase additional minutes for their cellular phone 10. The customer may stop at either a menu board or a drive up window 14 and order additional minutes and/or food 16. When the customer pays, the cashier need only swipe the activation card through the activation box 18, input the minutes purchased onto the keypad 20, and then ring up the transaction 22.

The activation box transmits the additional minutes and cellular phone identification to an activation center 24. The activation center will either automatically reactivate the customer's cellular phone with the correct amount of prepaid minutes 26 or a reactivation number will be printed on the customer's receipt 28. If a reactivation number is issued, the customer must input the number into their cellular phone to reactivate the phone 30.

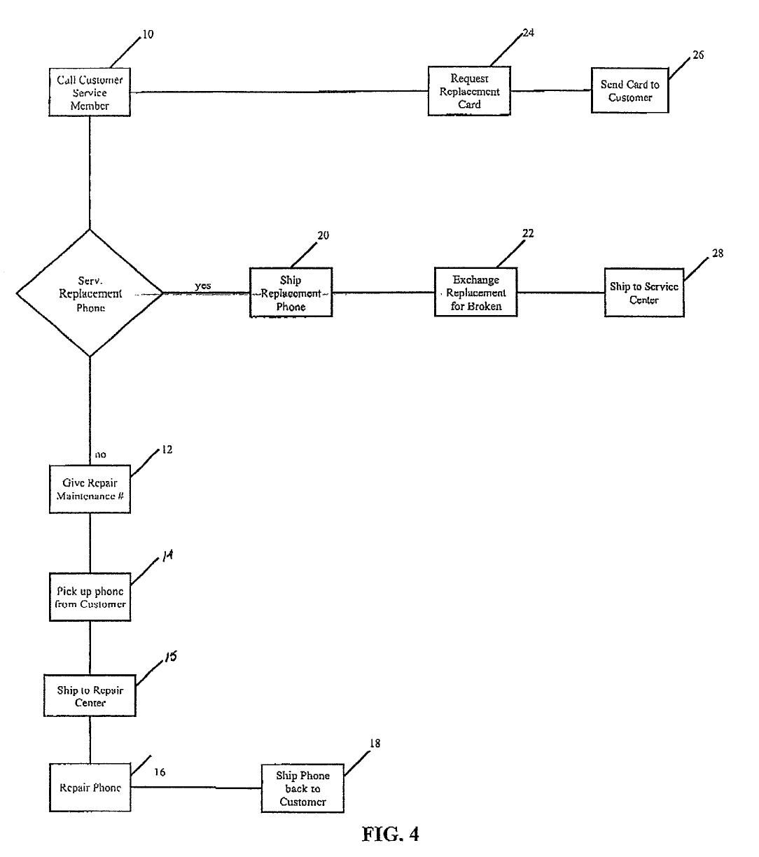

Now referring to FIG. 4, additional features. Additional features offered may include a customer service hotline. The customer will call the customer service number when they have problems with their phone 10. If the phone needs servicing, the customer will be given a repair maintenance authorization number 12. The phone will be picked up from the customer's home or any customer specified site 14 and shipped to a repair center 15 by UPS, FEDEX, or any other designated common carrier. Although any packaging will do, the original box the phone was sold in is designed for shipping and can be used. Once repaired 16, the phone will be shipped back to the customer 18.

The customer may also purchase a free replacement phone feature. Again, the customer will call the customer service number 10 when they have problems with their phone. The replacement phone will be shipped to the customer, preferably by overnight shipping 20. When the replacement phone is delivered, the customer will exchange the broken phone for the replacement phone 22. The broken phone will be returned to the service center 28.

If the customer misplaces the activation card, the customer will call the customer service center 10 and request a replacement activation card 24. The replaced activation card will be sent to the customer 26.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. An apparatus for activating, in a drive-thru setting, cellular phone time comprising;
an activation card and;
an action box, said activation box having a means for reading information on said activation card, said activation box virtually linked to an activation center.

2. The apparatus of claim 1 wherein said means for reading information is a magnetic stip on said activation card.

3. The apparatus of claim 1 wherein said means for reading information is a bar code on said activation card.

4. The apparatus of claim 1 wherein said means for reading information is a string of numbers on said activation card.

5. The apparatus of claim 2, 3, or 4 wherein said activation card is a plastic card.

6. The apparatus of claim 2, 3, or 4 wherein said activation card is a paper card.

7. The apparatus of claim 1 wherein said information read from said activation card is a cellular phone number.

8. A method of prepaying for cellular phone time, in a drive-thru setting, said method comprising;
establishing a business relationship with a cellular phone provider;
establishing drive-thru locations for an activation box;
installing said activation boxes in said drive-thru locations;
receiving an activation card from a customer;
swiping said activation card through said activation box;
inputting the number of minutes paid for and;
sending said minutes paid for and a cellular phone identification to an activation center, said activation center crediting said prepaid minutes to said cellular phone.

9. The method of claim 8 wherein said locations are the individual units of a retail chain.

10. The method of claim 8 wherein said locations are the individual units of a food chain.

11. The method of claim 8 wherein said activation card has a magnetic strip.

12. The method of claim 11 wherein a cellular phone identification is read from said magnetic strip.

13. The method of claim 8 wherein said activation card has a bar code.

14. The method of claim 13 wherein a cellular phone identification is read from said bar code.

15. The method of claim 8 wherein said activation card has a string of numbers.

16. The method of claim 15 wherein a cellular phone identification is read from said string of numbers.

17. The method of claim 8 wherein said activation center reactivates said cellular phone upon receipt of said minutes paid for and said cellular phone number.

18. The method of claim 8 wherein said activation center issues a number which prints out on a customer receipt, said customer reactivating said cellular phone by inputting said issued number therein.

19. The method of claim 8 further comprising the step of providing a customer service hotline comprising;
answering a customer call on said customer service hotline,
issuing a repair maintenance authorization number,
sending a common carrier to pick up said cellular phone,
receiving said cellular phone,
fixing said cellular phone,
returning said cellular phone to said customer by said common carrier.

20. The method of claim 8 further comprising the step of a free replacement phone option comprising;
selling an option to said customer of receiving a free replacement phone;
answering a customer call by a customer call on a customer service hotline,
sending a new cellular phone to said customer by a common carrier,
exchanging a broken phone for said new phone,
receiving said broken phone at a service center.

21. The method of claim 8 further comprising the step of replacing a lost activation card comprising;
receiving a customer call,
taking said customer's cellular phone number,
issuing a new activation card,
sending said new activation card to said customer.
